(19) United States
(12) Patent Application Publication
(10) Pub. No.: US 2025/0210290 A1
(43) Pub. Date: Jun. 26, 2025

(54) ELECTRIC CIRCUIT BREAKER DEVICE

(71) Applicant: Daicel Corporation, Osaka-shi, Osaka (JP)

(72) Inventor: Tomohide FUJIWARA, Tokyo (JP)

(73) Assignee: Daicel Corporation, Osaka-shi, Osaka (JP)

(21) Appl. No.: 18/846,280

(22) PCT Filed: Mar. 13, 2023
(86) PCT No.: PCT/JP2023/009590

§ 371 Date: Sep. 12, 2024

(30) Foreign Application Priority Data
Mar. 25, 2022 (JP) 2022-050290

(51) Int. Cl. H01H 39/00; H01H 9/30; H01H 9/52

(52) U.S. Cl. CPC H01H 39/006; H01H 9/30; H01H 9/52

(57) ABSTRACT

An electric circuit breaker device including: an igniter provided in a housing; a projectile disposed in an accommodation space formed in the housing and extending in one direction, the projectile being configured to be projected along the accommodation space by energy received from the igniter; a conductor piece provided in the housing and forming a part of an electric circuit, the conductor piece having, in a part of the conductor piece, a cutoff portion to be cut off by the projectile moving by energy received from the igniter, the cutoff portion being disposed crossing the accommodation space; and a coolant material positioned on a side of the projectile with respect to the cutoff portion before actuation of the igniter in the accommodation space.

### TECHNICAL FIELD

The present invention relates to an electric circuit breaker device.

### BACKGROUND ART

An electric circuit may be provided with a breaker device that is actuated when an abnormality occurs in a device constituting the electric circuit or when an abnormality occurs in a system in which the electric circuit is mounted, thereby urgently interrupting the continuity of the electric circuit. As one aspect thereof, there has been proposed an electric circuit breaker device that forcibly and physically cuts a conductor piece forming a portion of an electric circuit by moving a projectile at high speed by energy applied from an igniter or the like (see, for example, Patent Documents 1 to 7). Further, in recent years, electric circuit breaker devices applied to electric vehicles equipped with a high-voltage power source are becoming increasingly important.

### CITATION LIST

### Patent Literature

Patent Document 1: JP 2017-517134 A
Patent Document 2: JP 2019-212612 A
Patent Document 3: JP H08-279327 A
Patent Document 4: JP 2019-29152 A
Patent Document 5: JP 2019-36481 A
Patent Document 6: JP 2019-53907 A
Patent Document 7: JP 2021-128894 A

### SUMMARY OF INVENTION

### Technical Problem

In an electric circuit breaker device, an arc is likely to be generated when a conductor piece forming a part of an electric circuit is cut. If arc discharge during actuation of the electric circuit breaker device cannot be appropriately extinguished, there is a possibility of causing damage to the device to which the electric circuit breaker device is connected, and therefore, a technology for effectively extinguishing the arc is desired.

The technology of the present disclosure has been made in view of the above circumstances, and an object of the technology is to provide an electric circuit breaker device that can quickly extinguish an arc during actuation.

### Solution to Problem

To solve the above problem, an electric circuit breaker device according to an embodiment of the present disclosure includes:
an igniter provided in a housing;
a projectile disposed in an accommodation space formed in the housing and extending in one direction, the projectile being configured to be projected along the accommodation space by energy received from the igniter;
a conductor piece provided in the housing and forming a part of an electric circuit, the conductor piece including, in a part of the conductor piece, a cutoff portion to be cut off by the projectile moving by energy received from the igniter, the cutoff portion being disposed crossing the accommodation space; and
a coolant material positioned on a side of the projectile with respect to the cutoff portion before actuation of the igniter in the accommodation space.

### Advantageous Effects of Invention

According to the present disclosure, it is possible to provide an electric circuit breaker device capable of effectively extinguishing an arc generated during actuation.

### BRIEF DESCRIPTION OF DRAWINGS

FIG. 1 is a view illustrating an internal structure of an electric circuit breaker device (hereinafter, simply referred to as a “breaker device”) 1 according to an embodiment.

FIG. 2 is a top view of a conductor piece according to the embodiment.

FIG. 3 is a view illustrating actuation situations of the breaker device 1 according to the embodiment.

FIG. 4 is a view illustrating an internal structure of a breaker device 1A according to a modification 1.

FIG. 5 is a view illustrating an internal structure of a breaker device 1B according to a modification 2.

FIG. 6 is a view illustrating an internal structure of a breaker device 1C according to a modification 3.

### DESCRIPTION OF EMBODIMENTS

### First Embodiment

An electric circuit breaker device according to an embodiment of the present disclosure will be described below with reference to the drawings. Note that each of configurations, combinations thereof, and the like in the embodiments are an example, and various additions, omissions, substitutions, and other changes of the configurations may be made as appropriate without departing from the spirit of the present disclosure. The present disclosure is not limited by the embodiments and is limited only by the claims.

### Configuration

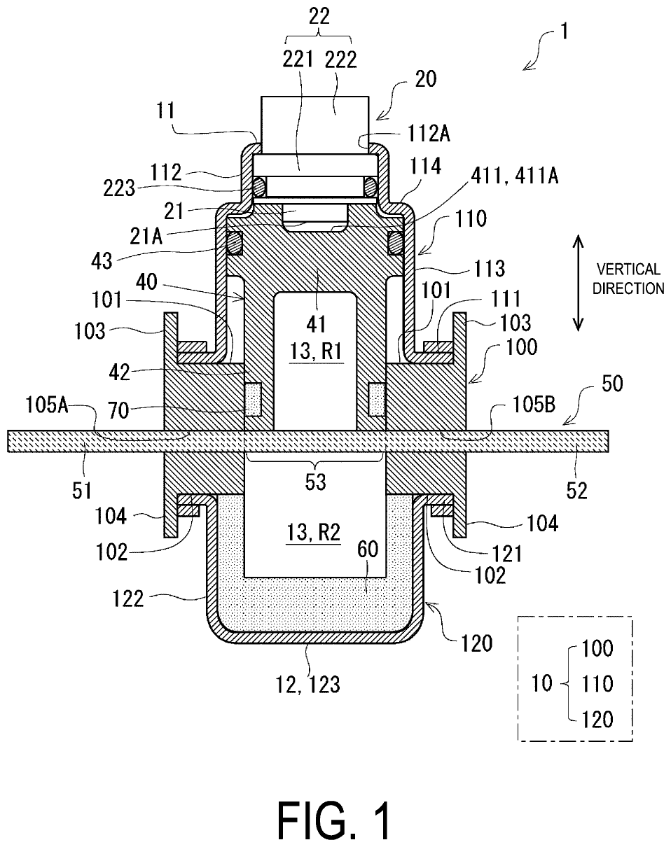

FIG. 1 is a view illustrating an internal structure of an electric circuit breaker device (hereinafter, simply referred to as a “breaker device”) 1 according to an embodiment. The breaker device 1 is a device that interrupts an electric circuit included in a vehicle, an electric home appliance, a photovoltaic system, or the like when an abnormality occurs in the electric circuit or in a system including a battery (lithium ion battery, for example) of the electric circuit, thereby preventing great damage. In the present specification, a cross section in the height direction in FIG. 1 (direction in which an accommodation space 13 described later extends) is referred to as a vertical cross section of the breaker device 1, and a cross section in a direction orthogonal to the height direction is referred to as a transverse cross section of the breaker device 1. FIG. 1 illustrates a state prior to actuation of the breaker device 1.

The breaker device 1 includes a housing 10 as an outer shell member, an igniter 20, a projectile 40, a conductor piece 50, a coolant material 60, and a coolant material 70. The housing 10 includes the accommodation space 13 that extends in a direction from a first end portion 11 on an upper end side to a second end portion 12 on a lower end side. This accommodation space 13 is a space formed linearly, making the projectile 40 movable, and extends along a vertical direction of the breaker device 1. As illustrated in FIG. 1, the accommodation space 13 formed inside the housing 10 accommodates the projectile 40. However, in the present specification, the vertical direction of the breaker device 1 merely indicates a relative positional relationship among the elements in the breaker device 1 for convenience of description of the embodiment.

### Housing

The housing 10 includes a housing body 100, a top holder 110, and a bottom container 120. The housing body 100 is bonded to the top holder 110 and the bottom container 120, thereby forming the housing 10 that is integral.

The housing body 100 has, for example, a substantially prismatic outer shape. However, the shape of the housing body 100 is not particularly limited. The housing body 100 includes a cavity portion formed therethrough along the vertical direction. This cavity portion forms a portion of the accommodation space 13. Furthermore, the housing body 100 includes an upper surface 101 to which a flange portion 111 of the top holder 110 is fixed and a lower surface 102 to which a flange portion 121 of the bottom container 120 is fixed. In the present embodiment, an upper tubular wall 103 having a tubular shape is provided erected upward from the upper surface 101 on the outer circumferential side of the upper surface 101 in the housing body 100. In the present embodiment, the upper tubular wall 103 has a rectangular tubular shape, for example, but may have other shapes. On the outer circumferential side of the lower surface 102 in the housing body 100, a lower tubular wall 104 having a tubular shape is provided suspended downward from the lower surface 102. In the present embodiment, the lower tubular wall 104 has a rectangular tubular shape, for example, but may have other shapes. The housing body 100 configured as described above can be formed from an insulating member such as a synthetic resin, for example. For example, the housing body 100 may be formed from nylon, which is a type of polyamide synthetic resin.

### Top Holder

Next, the top holder 110 will be described. The top holder 110 is, for example, a cylindrical member having a stepped cylindrical tubular shape with a hollow inside. The top holder 110 includes a small diameter cylinder portion 112 positioned on the upper side (first end portion 11 side), a large diameter cylinder portion 113 positioned on the lower side, a connection portion 114 connecting these, and the flange portion 111 extending outward from a lower end of the large diameter cylinder portion 113. For example, the small diameter cylinder portion 112 and the large diameter cylinder portion 113 are coaxially disposed, and the large diameter cylinder portion 113 has a diameter slightly larger than that of the small diameter cylinder portion 112.

The contour of the flange portion 111 in the top holder 110 has a substantially quadrangular shape that fits inside the upper tubular wall 103 in the housing body 100. For example, the flange portion 111 may be integrally fastened to the upper surface 101 in the housing body 100 using a screw or the like, or may be fixed thereto by a rivet or the like, in a state of being disposed inside the upper tubular wall 103. Further, the top holder 110 may be bonded to the housing body 100 in a state where a sealant is applied between the upper surface 101 of the housing body 100 and a lower surface of the flange portion 111 in the top holder 110. This can increase airtightness of the accommodation space 13 formed in the housing 10. Further, instead of the sealant or in combination with the sealant, an O-ring may be interposed between the upper surface 101 of the housing body 100 and the flange portion 111 of the top holder 110 to increase the airtightness of the accommodation space 13.

The cavity portion formed inside the small diameter cylinder portion 112 in the top holder 110 functions as an accommodation space for accommodation a portion of the igniter 20 as illustrated in FIG. 1. Further, the cavity portion formed inside the large diameter cylinder portion 113 in the top holder 110 communicates with the cavity portion of the housing body 100 positioned below, and forms a portion of the accommodation space 13. The top holder 110 configured as described above can be formed from an appropriate metal member, such as stainless steel or aluminum, having excellent strength and durability, for example. However, a material for forming the top holder 110 is not particularly limited. Also, for the shape of the top holder 110, the above aspect is an example and other shapes may be adopted.

### Bottom Container

Next, the bottom container 120 will be described. The bottom container 120 has a substantially tubular bottomed shape with a hollow inside, and includes a side wall portion 122, a bottom wall portion 123 connected to a lower end of the side wall portion 122, and a flange portion 121 connected to an upper end of the side wall portion 122. The side wall portion 122 has, for example, a cylindrical tubular shape. The flange portion 121 extends outward from the upper end of the side wall portion 122. The contour of the flange portion 121 in the bottom container 120 has a substantially quadrangular shape that fits inside the lower tubular wall 104 in the housing body 100. For example, the flange portion 121 may be integrally fastened to the lower surface 102 in the housing body 100 using a screw or the like, or may be fixed thereto by a rivet or the like, in a state of being disposed inside the lower tubular wall 104. Here, the bottom container 120 may be bonded to the housing body 100 in a state where the sealant is applied between the lower surface 102 of the housing body 100 and an upper surface of the flange portion 121 in the bottom container 120. This can increase airtightness of the accommodation space 13 formed in the housing 10. Further, instead of the sealant or in combination with the sealant, an O-ring may be interposed between the lower surface 102 of the housing body 100 and the flange portion 121 of the bottom container 120 to increase the airtightness of the accommodation space 13.

Note that the above aspect regarding the shape of the bottom container 120 is an example, and other shapes may be adopted. Further, the cavity portion formed inside the bottom container 120 communicates with the housing body 100 positioned above, and forms a portion of the accommodation space 13. The bottom container 120 configured as described above can be formed from an appropriate metal member, such as stainless steel or aluminum, having excellent strength and durability, for example. However, a material for forming the bottom container 120 is not particularly limited. Further, the bottom container 120 may have a multilayer structure. For example, in the bottom container 120, an exterior portion facing the outside may be formed using an appropriate metal member, such as stainless steel or aluminum, having excellent strength and durability, and an interior portion facing the accommodation space 13 may be formed using an insulating member such as a synthetic resin. Of course, the entire bottom container 120 may be formed using an insulating member.

As described above, the housing 10 in the embodiment includes the housing body 100, the top holder 110, and the bottom container 120 that are integrally assembled, and the accommodation space 13 extending in the direction from the first end portion 11 to the second end portion 12 is formed inside the housing 10. This accommodation space 13 accommodates the igniter 20, the projectile 40, a cutoff portion 53 of the conductor piece 50, the coolant material 60, and the like described in detail below.

### Igniter

Next, the igniter 20 will be described. The igniter 20 is an electric igniter that includes an ignition portion 21 with an ignition charge, and an igniter body 22 including a pair of electro-conductive pins (not illustrated) connected to the ignition portion 21. The igniter body 22 is surrounded by an insulating resin, for example. Further, tip end sides of the pair of electro-conductive pins in the igniter body 22 are exposed to the outside, and are connected to a power source when the breaker device 1 is used.

The igniter body 22 includes a body portion 221 having a substantially circular columnar shape and accommodated inside the small diameter cylinder portion 112 in the top holder 110, and a connector portion 222 positioned on the body portion 221. The igniter body 22 is fixed to the small diameter cylinder portion 112 by press-fitting, for example, the body portion 221 to an inner circumferential surface of the small diameter cylinder portion 112. Further, a constricted portion having an outer circumferential surface recessed as compared with other locations is annularly formed along a circumferential direction of the body portion 221 at an axially intermediate portion of the body portion 221. An O-ring 223 is fitted into this constricted portion. The O-ring 223 is formed from, for example, rubber (silicone rubber, for example) or a synthetic resin, and functions to increase airtightness between the inner circumferential surface in the small diameter cylinder portion 112 and the body portion 221.

The connector portion 222 in the igniter 20 is disposed protruding to the outside through an opening 112A formed at an upper end of the small diameter cylinder portion 112. The connector portion 222 has, for example, a cylindrical tubular shape covering sides of the electro-conductive pins, allowing connection with a connector of a power source.

As illustrated in FIG. 1, the ignition portion 21 of the igniter 20 is disposed facing the accommodation space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of electro-conductive pins to each other. As the ignition charge, for example, zirconium-potassium perchlorate (ZPP), zirconium-tungsten-potassium perchlorate (ZWPP), titanium hydride-potassium perchlorate (THPP), lead tricinate, or the like may be adopted.

In actuation of the igniter 20, when an actuating current for igniting the ignition charge is supplied from the power source to the electro-conductive pins, the bridge wire in the ignition portion 21 generates heat, and as a result, the ignition charge in the igniter cup is ignited and burns, generating a combustion gas. Then, the pressure in the igniter cup increases along with the combustion of the ignition charge in the igniter cup of the ignition portion 21, a rupture surface 21A of the igniter cup ruptures, and the combustion gas is discharged from the igniter cup into the accommodation space 13. More specifically, the combustion gas from the igniter cup is discharged into a depressed portion 411 in a piston portion 41 described later of the projectile 40 disposed in the accommodation space 13.

### Projectile

Next, the projectile 40 will be described. The projectile 40 is formed from an insulating member such as a synthetic resin, for example, and includes the piston portion 41 and a rod portion 42 connected to the piston portion 41. The piston portion 41 has a substantially circular columnar shape and has an outer diameter substantially corresponding to an inner diameter of the large diameter cylinder portion 113 in the top holder 110. For example, the diameter of the piston portion 41 may be slightly smaller than the inner diameter of the large diameter cylinder portion 113. The shape of the projectile 40 can be changed as appropriate according to the shape of the housing 10 and the like.

Further, the depressed portion 411 having a circular columnar shape, for example, is formed in an upper surface of the piston portion 41. This depressed portion 411 receives the ignition portion 21. A bottom surface of the depressed portion 411 is formed as a pressure receiving surface 411A that receives energy received from the igniter 20 during actuation of the igniter 20. Further, a constricted portion having an outer circumferential surface recessed as compared with other locations is annularly formed along a circumferential direction of the piston portion 41 at an axially intermediate portion of the piston portion 41. An O-ring 43 is fitted into this constricted portion. The O-ring 43 is formed from, for example, rubber (silicone rubber, for example) or a synthetic resin, and functions to increase airtightness between an inner circumferential surface in the large diameter cylinder portion 113 and the piston portion 41.

The rod portion 42 of the projectile 40 is a rod-shaped member having an outer circumferential surface smaller in diameter than the piston portion 41, for example, and is integrally connected to a lower end side of the piston portion 41. A lower end surface of the rod portion 42 is formed as a cutoff surface 421 for cutting off the cutoff portion 53 from the conductor piece 50 during actuation of the breaker device 1. Note that although the rod portion 42 in the present embodiment has a substantially cylindrical tubular shape, the shape thereof is not particularly limited, and can be changed in accordance with the shape and size of the cutoff portion 53 to be cut off from the conductor piece 50 during actuation of the breaker device 1. The rod portion 42 may have a columnar shape such as a circular column or a rectangular column, for example. Note that, in an initial position of the projectile 40 illustrated in FIG. 1, a region on a tip end side including the cutoff surface 421 in the rod portion 42 of the projectile 40 is positioned in the cavity portion (forming a portion of the accommodation space 13) of the housing body 100. The diameter of the rod portion 42 is slightly smaller than the inner diameter of an inner circumferential surface of the housing body 100, for example, and the outer circumferential surface of the rod portion 42 is guided along the inner circumferential surface when the projectile 40 is projected.

Further, a constricted portion having an outer circumferential surface depressed as compared with other locations is annularly formed along a circumferential direction of the rod portion 42 of the projectile 40 at an axially intermediate portion of the rod portion 42. The coolant material 70 is fitted into this constricted portion. The constricted portion into which the coolant material 70 is fitted is an accommodation space for the coolant material 70. The constricted portion into which the coolant material 70 is fitted is positioned, after actuation of the projectile 40, on a side opposite to a side of the projectile 40 with respect to the cutoff portion 53 before actuation. That is, the constricted portion into which the coolant material 70 is fitted is disposed so as to be positioned, after actuation of the projectile 40, on the bottom container 120 side with respect to the remaining conductor piece 50 from which the cutoff portion 53 is cut off. Further, the constricted portion may be formed not annularly along the circumferential direction of the rod portion 42 but in two arc shapes separately on a conductor piece holding hole 105A side and a conductor piece holding hole 105B side. At this time, the coolant material 70 also exists separately on the conductor piece holding hole 105A side and the conductor piece holding hole 105B side. The constricted portion of the projectile 40 is an example of a projectile outer circumferential accommodation space provided in an outer circumferential surface of the projectile 40.

As described in detail later, the projectile 40 configured as described above is projected from the initial position illustrated in FIG. 1 when the upper surface of the piston portion 41 including the pressure receiving surface 411A receives the energy from the igniter 20 during actuation of the igniter 20, and moves at high speed toward the second end portion 12 side (downward) along the accommodation space 13. Specifically, as illustrated in FIG. 1, the piston portion 41 of the projectile 40 is accommodated inside the large diameter cylinder portion 113 in the top holder 110, and is slidable in the axis direction along an inner wall surface of the large diameter cylinder portion 113. In the present embodiment, the piston portion 41 of the projectile 40 has a substantially circular columnar shape, but the shape thereof is not particularly limited. As the outer shape of the piston portion 41, an appropriate shape and size can be adopted in accordance with the shape and size of the inner wall surface of the large diameter cylinder portion 113.

### Conductor Piece

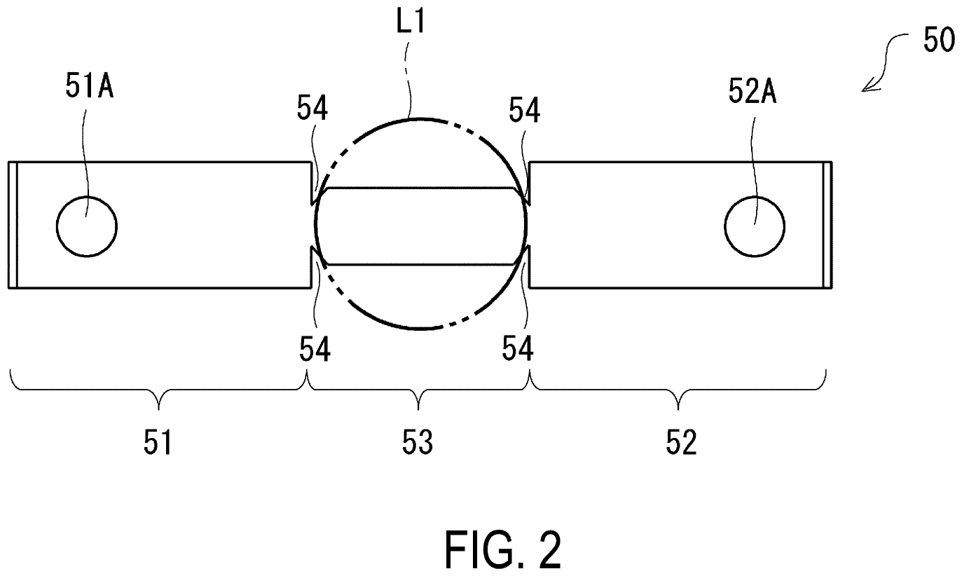

Next, the conductor piece 50 will be described. FIG. 2 is a top view of the conductor piece 50 according to the embodiment. The conductor piece 50 is a metal body having conductivity that constitutes a portion of the components of the breaker device 1 and, when the breaker device 1 is attached to a predetermined electric circuit, forms a portion of the electric circuit, and may be referred to as a bus bar. The conductor piece 50 can be formed from a metal such as copper (Cu), for example. However, the conductor piece 50 may be formed using a metal other than copper, or may be formed using an alloy of copper and another metal. Note that examples of metals other than copper included in the conductor piece 50 include manganese (Mn), nickel (Ni), and platinum (Pt).

In one aspect illustrated in FIG. 2, the conductor piece 50 is formed as an elongated flat plate piece as a whole, and includes a first connection end portion 51 and a second connection end portion 52 on both end sides, and the cutoff portion 53 positioned in an intermediate portion therebetween. Connection holes 51A, 52A are provided in the first connection end portion 51 and the second connection end portion 52 of the conductor piece 50, respectively. These connection holes 51A, 52A are used to connect with other conductors (lead wires, for example) in the electric circuit. Note that in FIG. 1, the connection holes 51A and 52A in the conductor piece 50 are not illustrated. The cutoff portion 53 of the conductor piece 50 is a portion forcibly and physically cut by the rod portion 42 of the projectile 40 and is cut off from the first connection end portion 51 and the second connection end portion 52 when an abnormality such as excessive current occurs in the electric circuit to which the breaker device 1 is applied. Notches (slits) 54 are formed at both ends of the cutoff portion 53 of the conductor piece 50, making it easy to cut and cut off the cutoff portion 53.

Here, various forms of the conductor piece 50 can be adopted, and a shape thereof is not particularly limited. While, in the example illustrated in FIG. 2, surfaces of the first connection end portion 51, the second connection end portion 52, and the cutoff portion 53 form the same surface, the form is not limited thereto. For example, the conductor piece 50 may be connected such that the cutoff portion 53 is orthogonal to or inclined relative to the first connection end portion 51 and the second connection end portion 52. Further, the planar shape of the cutoff portion 53 of the conductor piece 50 is not particularly limited, either. Of course, the shapes of the first connection end portion 51 and the second connection end portion 52 of the conductor piece 50 are not particularly limited, either. Further, the notches 54 in the conductor piece 50 can be omitted as appropriate.

Here, a pair of conductor piece holding holes 105A and 105B are formed in the housing body 100 according to the embodiment. The pair of conductor piece holding holes 105A and 105B extend in a transverse cross-sectional direction orthogonal to the vertical direction (axis direction) of the housing body 100. More specifically, the pair of conductor piece holding holes 105A and 105B extend in a straight line with the cavity portion (accommodation space 13) of the housing body 100 interposed therebetween. The conductor piece 50 configured as described above is held in the housing body 100 in a state of being inserted through the pair of conductor piece holding holes 105A and 105B formed in the housing body 100. In the example illustrated in FIG. 1, the first connection end portion 51 of the conductor piece 50 is held in a state of being inserted through the conductor piece holding hole 105A, and the second connection end portion 52 is held in a state of being inserted through the conductor piece holding hole 105B. In this state, the cutoff portion 53 of the conductor piece 50 is positioned in the cavity portion (accommodation space 13) of the housing body 100. As described above, the conductor piece 50 attached to the housing body 100 is held orthogonally to the extending direction (axis direction) of the accommodation space 13 with the cutoff portion 53 crossing the accommodation space 13. Note that reference sign L1 illustrated in FIG. 2 denotes an outer circumferential position of the rod portion 42 positioned above the conductor piece 50 in a state of being attached to the housing body 100 of the breaker device 1. In the present embodiment, the conductor piece 50 is installed with the outer circumferential position L1 of the rod portion 42 substantially overlapping the positions of the notches 54 positioned at both ends of the cutoff portion 53. In the present embodiment, for example, since a transverse cross-sectional area of the accommodation space 13 is larger than a transverse cross-sectional area of the cutoff portion 53, a gap is formed on the side of the cutoff portion 53.

### Coolant Material

Next, the coolant material 60 disposed in the accommodation space 13 in the housing 10 will be described. Here, as illustrated in FIG. 1, prior to actuation of the breaker device 1 (igniter 20), the cutoff portion 53 of the conductor piece 50 in a state of being held in the pair of conductor piece holding holes 105A and 105B in the housing body 100 is horizontally laid crossing the accommodation space 13 of the housing 10. Hereinafter, within the accommodation space 13 of the housing 10 separated by the cutoff portion 53 of the conductor piece 50, a region (space) in which the projectile 40 is disposed is referred to as a “projectile initial arrangement region R1”, and a region (space) positioned on the opposite side of the projectile 40 is referred to as an “arc-extinguishing region R2”. Note that as described above, since the gap is formed on the side of the cutoff portion 53 disposed across the accommodation space 13, the projectile initial arrangement region R1 and the arc-extinguishing region R2 are not completely isolated from each other by the cutoff portion 53, but communicate with each other. Of course, depending on the shape and size of the cutoff portion 53, the projectile initial arrangement region R1 and the arc-extinguishing region R2 may be completely isolated from each other by the cutoff portion 53.

The arc-extinguishing region R2 of the accommodation space 13 is a region (space) for receiving the cutoff portion 53 cut off by the rod portion 42 of the projectile 40 projected during actuation of the breaker device 1 (igniter 20). In this arc-extinguishing region R2, the coolant material 60 as an arc-extinguishing material is disposed. The coolant material 70 is disposed on the outer circumference of the rod portion 42. The coolant material 60 and the coolant material 70 are coolant materials for removing thermal energy of the arc generated and the cutoff portion 53 when the projectile 40 cuts off the cutoff portion 53 of the conductor piece 50, and cooling the arc and the cutoff portion 53, thereby suppressing are generation during cutting off of a current or thereby extinguishing (eliminating) the generated arc.

The arc-extinguishing region R2 of the breaker device 1 has significance as a space for receiving the cutoff portion 53 cut off from the first connection end portion 51 and the second connection end portion 52 of the conductor piece 50 by the projectile 40 and, at the same time, as a space for effectively extinguishing the arc generated when the projectile 40 cuts off the cutoff portion 53. Then, in order to effectively extinguish the arc generated when the cutoff portion 53 is cut off from the conductor piece 50, the coolant material 60 is disposed as an arc-extinguishing material in the arc-extinguishing region R2. Furthermore, the coolant material 70 is disposed as an arc-extinguishing material on the outer circumference of the rod portion 42.

As one aspect of the embodiment, the coolant material 60 is solid. As one aspect of the embodiment, the coolant material 60 is formed from a shape retaining body. The shape retaining body herein is, for example, a material that can keep a constant shape when no external force is applied and can hold the integrity (does not come apart), even if deformation can occur, when an external force is applied. For example, examples of the shape retaining body include a fibrous body formed into a desired shape. In the present embodiment, the coolant material 60 is formed from a metal fiber that is a shape retaining body. Here, examples of the metal fiber forming the coolant material 60 include an aspect in which at least any one of steel wool or copper wool is included. The coolant material 60 may include an inorganic oxide such as zeolite, silica, or alumina. However, the above aspects in the coolant material 60 are examples, and the coolant material 60 is not limited to the above aspects. The coolant material 70 fitted into the rod portion 42 of the projectile 40 is similar to the coolant material 60.

The coolant material 60 is formed into, for example, a bowl-like shape, and is disposed along an inner wall and a bottom portion of the bottom container 120.

The coolant material 60 and the coolant material 70 may be modified resin materials functioning as arc-extinguishing materials. When the igniter 20 is actuated, the modified resin material is modified by the arc generated by the projectile 40 cutting off the cutoff portion 53 of the conductor piece 50 and the heat of the cutoff portion 53, and this modification consumes thermal energy, thereby contributing to extinguishing (eliminating) of the arc. Note that the modified resin material is modified mainly by heat of the arc, but in addition to this, the modified resin material is affected by heat such as the heat generated when the cutoff portion 53 is cut off and combustion heat of the ignition charge, and heat received from ignition of the ignition charge, and the heat received from ignition of the ignition charge to extinguishing completion is called heat associated with actuation of the igniter 20.

The modified resin material is a synthetic resin including silicone. Note that the modified resin material is not limited to silicone, and may be a material using another resin such as polyurethane, polyethylene, polypropylene, polyamide, or nitrile rubber. The modified resin material may be any material as long as at least a part thereof is modified by heat, and may be made of a composite material including glass, ceramic fillers, or the like. The modified resin material is made of a material that is easily modified such as being decomposed or being volatilized by heat as compared with other resin materials such as the housing 10 and the projectile 40, and the heat of the arc can be effectively consumed by this modification. In the modified resin material of the present embodiment, a component such as silica generated by thermal decomposition exhibits a high resistance value, and scattering of the components contributes to improvement of insulation after cutting.

The modified resin material is not limited to a solid member formed in a predetermined shape, and may be used by applying a gel-like material or a highly viscous liquid material to a wall surface in the accommodation space 13. The modified resin material may be fixedly provided to the wall surface of the accommodation space 13 by applying a synthetic resin melted with an organic solvent such as toluene to the wall surface and then volatilizing the organic solvent.

### Operation

Next, operation content when the breaker device 1 is actuated to interrupt the electric circuit will be described. As described above, FIG. 1 illustrates a state of the breaker device 1 prior to actuation (hereinafter also referred to as the “pre-actuation initial state”). In this pre-actuation initial state, in the projectile 40 in the breaker device 1, the piston portion 41 is positioned on the first end portion 11 side (upper end side) in the accommodation space 13, and the cutoff surface 421 formed at the lower end of the rod portion 42 is set at an initial position positioned on the upper surface of the cutoff portion 53 in the conductor piece 50.

Furthermore, the breaker device 1 according to the embodiment further includes an abnormality detection sensor (not illustrated) that detects an abnormal state of a device (such as a vehicle, a power generation facility, or a power storage facility) to which an electric circuit to be cut off is connected, and a control unit (not illustrated) that controls the actuation of the igniter 20. The abnormality detection sensor may be capable of detecting an abnormal state on the basis of a voltage or a temperature of the conductor piece 50 in addition to the current flowing through the conductor piece 50. Further, the abnormality detection sensor may be, for example, an impact sensor, a temperature sensor, an acceleration sensor, a vibration sensor, or the like, and may detect an abnormal state such as an accident or fire on the basis of an impact, a temperature, acceleration, or vibration in a device such as a vehicle. The control unit of the breaker device 1 is a computer capable of performing a predetermined function by executing a predetermined control program, for example. The predetermined function of the control unit may be realized by corresponding hardware. Then, when excessive current flows through the conductor piece 50 forming a portion of the electric circuit to which the breaker device 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the electro-conductive pins of the igniter 20 and actuates the igniter 20 based on the current value detected by the abnormality detection sensor. Here, the abnormal current may be a current value that exceeds a predetermined threshold value set for protection of a predetermined electric circuit. Note that the abnormality detection sensor and the control unit described above need not be included in the constituent elements of the breaker device 1, and may be included in a device separate from the breaker device 1, for example. Further, the abnormality detection sensor and the control unit are not essential components of the breaker device 1.

For example, when an abnormal current of the electric circuit is detected by an abnormality detection sensor that detects an abnormal current of the electric circuit, the control unit of the breaker device 1 actuates the igniter 20. That is, an actuating current is supplied from the external power source (not illustrated) to the electro-conductive pins of the igniter 20, and as a result, the ignition charge in the ignition portion 21 is ignited and burns, generating a combustion gas. Then, the rupture surface 21A ruptures due to rise in pressure in the ignition portion 21, and the combustion gas of the ignition charge is discharged from the inside of the ignition portion 21 into the accommodation space 13.

Here, the ignition portion 21 of the igniter 20 is received in the depressed portion 411 of the piston portion 41, and the rupture surface 21A of the ignition portion 21 is disposed facing the pressure receiving surface 411A of the depressed portion 411 in the projectile 40. Therefore, the combustion gas from the ignition portion 21 is discharged to the depressed portion 411, and the pressure (combustion energy) of the combustion gas is transmitted to the upper surface of the piston portion 41 including the pressure receiving surface 411A. As a result, the projectile 40 moves downward in the accommodation space 13 in the extending direction (axis direction) of the accommodation space 13.

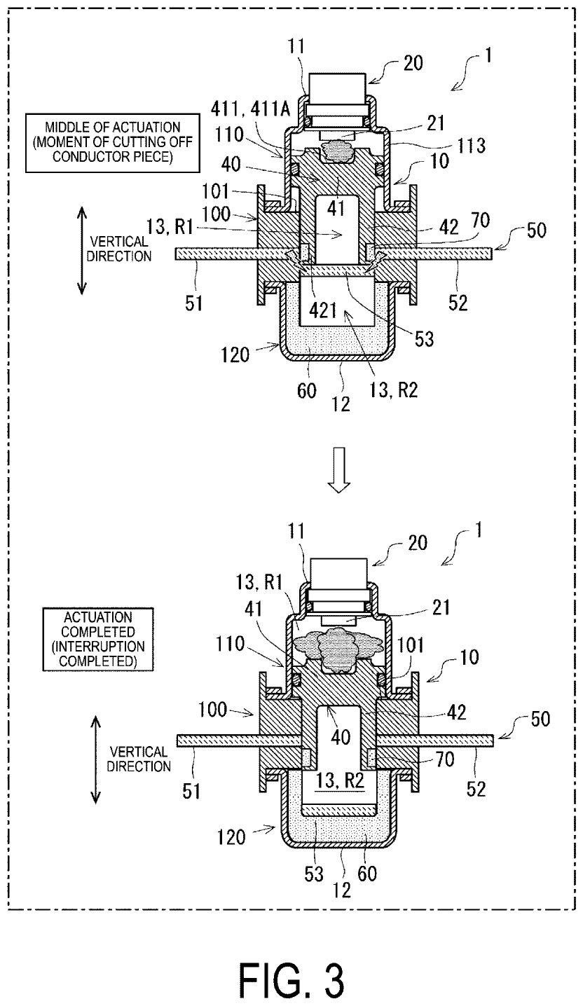

FIG. 3 is a view illustrating actuation situations of the breaker device 1 according to the embodiment. The upper half of FIG. 3 illustrates a situation in the middle of actuation of the breaker device 1, and the lower half of FIG. 3 illustrates a situation in which the actuation of the breaker device 1 is completed. As described above, upon actuation of the igniter 20, the projectile 40 having received the pressure (combustion energy) of the combustion gas of the ignition charge is vigorously pushed downward. As a result, the cutoff surface 421 formed on the lower end side of the rod portion 42 pressingly cuts, by shearing, the boundary portions between the first connection end portion 51 and the cutoff portion 53 and between the second connection end portion 52 and the cutoff portion 53 in the conductor piece 50. As a result, the cutoff portion 53 is cut off from the conductor piece 50. Note that as long as the projectile 40 can be moved smoothly in the extending direction (axis direction) of the accommodation space 13 when the igniter 20 is actuated, the shape and the dimensions of the projectile 40 can be freely determined, and the outer diameter of the piston portion 41 of the projectile 40 may be set to a dimension equal to the inner diameter of the large diameter cylinder portion 113 in the top holder 110, for example.

Then, as illustrated in the lower half of FIG. 3, the projectile 40 moves downward in the extending direction (axis direction) of the accommodation space 13 by a predetermined stroke until the lower end surface of the piston portion 41 abuts (collides with) the upper surface 101 of the housing body 100. In this state, the cutoff portion 53 cut off from the conductor piece 50 by the rod portion 42 of the projectile 40 is received in the arc-extinguishing region R2 where the coolant material 60 is disposed. As a result, the first connection end portion 51 and the second connection end portion 52 positioned on both ends of the conductor piece 50 are electrically disconnected, and the predetermined electric circuit to which the breaker device 1 is applied is forcibly interrupted.

In the breaker device 1 in the embodiment, the coolant material 60 is disposed in the arc-extinguishing region R2, and the coolant material 70 is disposed in the rod portion 42. Therefore, the cutoff portion 53 after being cut off that has been received in the arc-extinguishing region R2 can be rapidly cooled by the coolant material 60. When the projectile 40 moves, the coolant material 70 disposed on the outer circumferential surface of the rod portion 42 exists between the cutoff portion 53 and the remaining conductor piece 50. Thus, when the cutoff portion 53 is cut off from the conductor piece 50 constituting a portion of the predetermined electric circuit by the projectile 40, even in a case where an arc is generated at the cut surface of the cutoff portion 53 of the conductor piece 50, the generated arc can be quickly and effectively extinguished.

Furthermore, in the breaker device 1, the coolant material 70 as an arc-extinguishing material is disposed on the outer circumferential surface of the rod portion 42. This can quickly and effectively extinguish the arc immediately after the rod portion 42 cuts off the cutoff portion 53 from the conductor piece 50, that is, when the arc is generated by cutting off. Further, the constricted portion into which the coolant material 70 is fitted is disposed so as to be positioned, after actuation of the projectile 40, on the bottom container 120 side with respect to the remaining conductor piece 50 from which the cutoff portion 53 is cut off. This can help prevent the conductor piece 50 after cutting from conducting electricity via the coolant material 70.

As described above, according to the breaker device 1 of the present embodiment, the coolant material 60 and the coolant material 70 cool the cutoff portion 53, and generation of the arc can be effectively suppressed. As a result, it is possible to quickly interrupt the electric circuit to which the breaker device 1 is applied in a case where an abnormality is detected in the electric circuit, or the like. That is, by effectively suppressing delay in extinguishing of the arc generated when the electric circuit is interrupted, it is possible to suppress delay in interruption of the electric circuit. By effectively cooling the heat of the arc by the coolant material 60 and the coolant material 70, evaporation of the conductor piece 50 having been cut can be suppressed, and the insulation resistance after cutting can be made a sufficiently high value. Furthermore, according to the breaker device 1, it is possible to suitably help prevent a large spark or flame from occurring and a large impact sound from being generated during cutting off of the electric circuit. Further, damage to the housing 10 and the like of the breaker device 1 caused by these can also be suppressed.

### First Modification

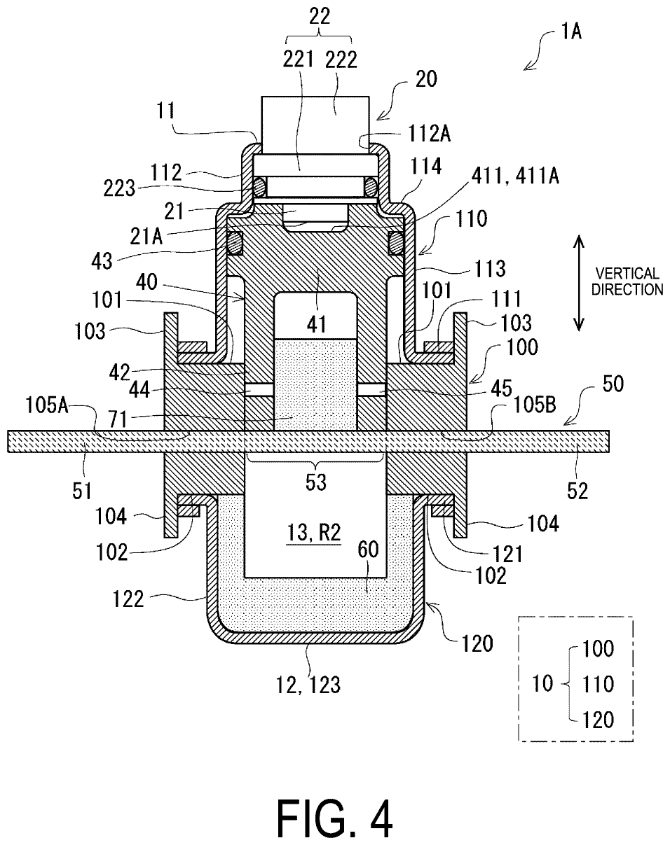

For the breaker device 1 according to the embodiment, various modifications can be adopted. For example, the shape, position, range, and the like of the coolant material 70 disposed, before actuation, on the projectile 40 side with respect to the conductor piece can be appropriately changed. For example, FIG. 4 is a view illustrating an internal structure of a breaker device 1A according to a modification 1. Unlike the configuration of the breaker device 1 illustrated in FIG. 1, the breaker device 1A of the present modification 1 has a configuration in which a coolant material 71 in place of the coolant material 70 is disposed inside the rod portion 42 of the projectile 40 and a through hole 44 and a through hole 45 are disposed in the rod portion 42 of the projectile 40. The rod portion 42 internally includes a recessed portion opening to the lower surface. The coolant material 71 is disposed in the recessed portion. The recessed portion is an accommodation space (projectile inner accommodation space) for the coolant material 71. The coolant material 71 entirely or partially fills the recessed portion of the rod portion 42 of the projectile 40. The through hole 44 is a hole extending between the outside of the rod portion 42 and the accommodation space, and is provided on the conductor piece holding hole 105A side. The through hole 45 is a hole extending between the outside of the rod portion 42 and the accommodation space, and is provided on the conductor piece holding hole 105B side. The material of the coolant material 71 is similar to those of the coolant material 60 and the coolant material 70. The coolant material 70 may be disposed inside the through holes 44 and 45. The through holes 44 and 45 are arranged so as to be positioned, after actuation of the projectile 40, on the bottom container 120 side with respect to the remaining conductor piece 50 from which the cutoff portion 53 is cut off. This can help prevent the conductor piece 50 after cutting from conducting electricity via the through holes 44 and 45 and the coolant material 71. Note that since the other configurations are the same, the description thereof will be omitted.

The coolant material 71 is disposed in the internal space (projectile inner accommodation space) of the rod portion 42 of the projectile 40 before actuation of the igniter 20. Due to this, when the projectile 40 is projected by actuation of the igniter 20, the coolant material 71 moves to the bottom container 120 together with the rod portion 42. When the rod portion 42 cuts off the cutoff portion 53 and an arc is generated, the coolant material 71 removes heat of the arc through the through hole 44, the through hole 45, and the like to cool the arc. The coolant material 71 is disposed in the recessed portion opening to the lower surface of the rod portion 42. Therefore, the coolant material 71 can directly remove heat from the cutoff portion 53 existing on a lower surface side of the rod portion 42. This allows the cutoff portion 53 to be cooled by the coolant material 71 at the moment when the cutoff portion 53 is cut off from the conductor piece 50 by the cutoff surface 421 of the rod portion 42 and immediately thereafter, that is, also in a transient state from the moment when the cutoff portion 53 is cut off from the conductor piece 50 until the cutoff portion 53 comes into contact with the coolant material 60 disposed in the arc-extinguishing region R2. This makes it possible to suitably suppress the generation of an arc at the cut surface of the cutoff portion 53 in the transient state at the moment when the cutoff portion 53 is cut off from the conductor piece 50 and immediately thereafter. Second Modification

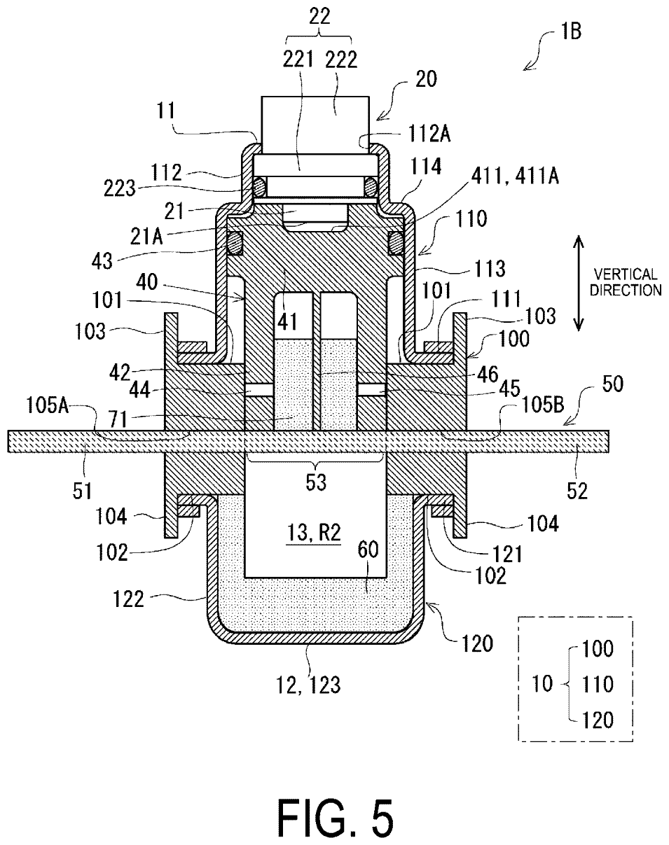

FIG. 5 is a view illustrating an internal structure of a breaker device 1B according to a modification 2. The breaker device 1B of the present modification 2 has a configuration in which a partition wall 46 is disposed inside the rod portion 42 of the projectile 40 in addition to the configuration of the breaker device 1A illustrated in FIG. 4. The partition wall 46 is a wall that separates the inside of the rod portion 42 (recessed portion opening to the lower surface) into a space (projectile inner accommodation space) on the conductor piece holding hole 105A side and a space side (projectile inner accommodation space) on the conductor piece holding hole 105B. The partition wall 46 is formed from an insulating member such as a synthetic resin integrally with the piston portion 41, the rod portion 42, and the like, for example. At this time, the coolant material 71 is also separated into the conductor piece holding hole 105A side and the conductor piece holding hole 105B side. Note that since the other configurations are the same, the description thereof will be omitted. When the projectile 40 is projected by actuation of the igniter 20, the partition wall 46 can prevent electrical conduction of the conductor piece 50 on the conductor piece holding hole 105A side and the conductor piece 50 on the conductor piece holding hole 105A side, which are cut, by the coolant material 71 inside the rod portion 42. The coolant material 71 may be disposed so as to be positioned, after actuation of the igniter 20, on a side opposite to a side of the projectile 40 with respect to the cutoff portion 53 before actuation of the igniter 20.

### Third Modification

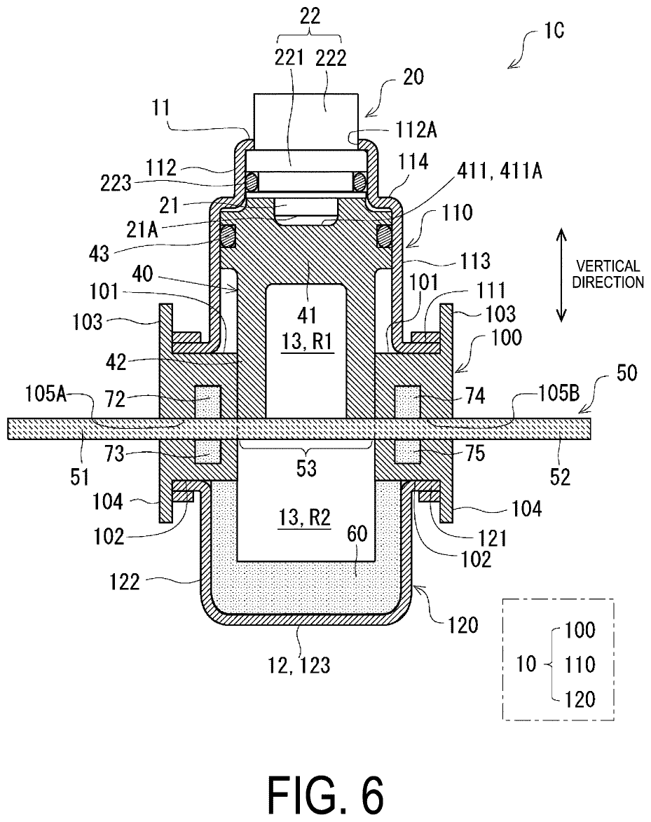

FIG. 6 is a view illustrating an internal structure of a breaker device 1C according to a modification 3. Unlike the configuration of the breaker device 1 illustrated in FIG. 1, the breaker device 1C of the present modification 3 has a configuration in which coolant materials 72, 73, 74, and 75 are disposed in place of the coolant material 70. The inside of the housing body 100 is provided with a space (coolant material accommodation space) for accommodating the coolant materials 72, 73, 74, and 75. The space is provided above and below the conductor piece holding hole 105A of the housing body 100 and above and below the conductor piece holding hole 105B of the housing body 100. Any of the spaces may be omitted. Each of the spaces is connected to the conductor piece holding hole 105A or the conductor piece holding hole 105B. The coolant materials 72 and 73 are accommodated in the space above and the space below the conductor piece holding hole 105A of the housing body 100, respectively. The coolant materials 74 and 75 are accommodated in the space above and the space below the conductor piece holding hole 105B of the housing body 100, respectively. The space above the conductor piece holding hole 105A and the space above the conductor piece holding hole 105B may be connected. The space below the conductor piece holding hole 105A and the space below the conductor piece holding hole 105B may be connected. The materials of the coolant materials 72, 73, 74, and 75 are similar to those of the coolant material 60 and the coolant material 70. Note that since the other configurations are the same, the description thereof will be omitted. This allows the conductor piece 50 to be cooled by the coolant materials 72, 73, 74, and 75 at the moment when the cutoff portion 53 is cut off from the conductor piece 50 by the cutoff surface 421 of the rod portion 42 and immediately thereafter. This makes it possible to suitably suppress the generation of an arc at the cut surface of the conductor piece 50 in the transient state at the moment when the cutoff portion 53 is cut off from the conductor piece 50 and immediately thereafter.

While the embodiment of the electric circuit breaker device according to the present disclosure has been described above, each of the aspects disclosed in the present specification can be combined with any other feature disclosed in the present specification.

### REFERENCE SIGNS LIST

1 Breaker device
10 Housing
13 Accommodation space
20 Igniter
40 Projectile
50 Conductor piece
53 Cutoff portion
60 Coolant material
70 Coolant material

1. An electric circuit breaker device comprising:
an igniter provided in a housing;
a projectile disposed in an accommodation space formed in the housing and extending in one direction, the projectile being configured to be projected along the accommodation space by energy received from the igniter;
a conductor piece provided in the housing and forming a part of an electric circuit, the conductor piece including, in a part of the conductor piece, a cutoff portion to be cut off by the projectile moving by energy received from the igniter, the cutoff portion being disposed crossing the accommodation space; and
a coolant material positioned on a side of the projectile with respect to the cutoff portion before actuation of the igniter in the accommodation space.

2. The electric circuit breaker device according to claim 1, wherein
the coolant material is positioned, after actuation of the igniter, on a side opposite to a side of the projectile with respect to the cutoff portion before actuation of the igniter.

3. The electric circuit breaker device according to claim 1, wherein
the coolant material is disposed in a projectile outer circumferential accommodation space provided in an outer circumferential surface of the projectile.

4. The electric circuit breaker device according to claim 1, wherein
the coolant material is disposed in a projectile inner accommodation space provided inside the projectile.

5. The electric circuit breaker device according to claim 4, wherein
the projectile includes a through hole extending between the projectile inner accommodation space in which the coolant material is disposed and an outside of the projectile.

6. An electric circuit breaker device comprising:
an igniter provided in a housing;
a projectile disposed in an accommodation space formed in the housing and extending in one direction, the projectile being configured to be projected along the accommodation space by energy received from the igniter;
a conductor piece provided in the housing and forming a part of an electric circuit, the conductor piece including, in a part of the conductor piece, a cutoff portion to be cut off by the projectile moving by energy received from the igniter, the cutoff portion being disposed crossing the accommodation space; and
a coolant material disposed in a coolant material accommodation space provided inside the housing.

7. The electric circuit breaker device according to claim 1, wherein
the coolant material includes a fibrous body.

8. The electric circuit breaker device according to claim 1, wherein
the coolant material includes an inorganic oxide.

9. The electric circuit breaker device according to claim 8, wherein
the inorganic oxide includes zeolite.

10. The electric circuit breaker device according to claim 1, wherein
the coolant material includes a modified resin material.

11. The electric circuit breaker device according to claim 2, wherein
the coolant material is disposed in a projectile outer circumferential accommodation space provided in an outer circumferential surface of the projectile.

12. The electric circuit breaker device according to claim 2, wherein
the coolant material is disposed in a projectile inner accommodation space provided inside the projectile.

13. The electric circuit breaker device according to claim 3, wherein
the coolant material is disposed in a projectile inner accommodation space provided inside the projectile.

14. The electric circuit breaker device according to claim 6, wherein the coolant material includes a fibrous body.

15. The electric circuit breaker device according to claim 6, wherein the coolant material includes an inorganic oxide.

16. The electric circuit breaker device according to claim 15, wherein the inorganic oxide includes zeolite.

17. The electric circuit breaker device according to claim 6, wherein the coolant material includes a modified resin material.
